(19) United States
(12) Patent Application Publication
(10) Pub. No.: US 2013/0077641 A1
(43) Pub. Date: Mar. 28, 2013

(54) Systems, Circuits and Methods for Time Stamp Based One-Way Communications

(71) Applicant: Harley F. Burger, JR., San Jose, CA (US)

(72) Inventor: Harley F. Burger, JR., San Jose, CA (US)

(21) Appl. No.: 13/241,047

(22) Filed: Sep. 22, 2011

(51) Int. Cl. H04J 3/24

(52) U.S. Cl. 370/474

(57) ABSTRACT

A circuit includes an input terminal for receiving an input signal and a time stamp circuit including an input and an output. The input is coupled to the input terminal. The time stamp circuit includes a timer, and the output is for providing a time stamp based on a value of the timer in response to receiving the input signal. The circuit further includes an encoder including an input coupled to the output of the time stamp circuit and configured to encode the time stamp into a packet. The circuit also includes a transmitter configured to transmit the packet.

### FIELD

The present disclosure is generally related to one-way communication systems and circuits, and methods therefor.

### BACKGROUND

Conventional remotely controllable systems include a receiver for receiving a wireless signal to which the system responds. Such remotely controllable systems can include movable barriers, such as garage doors, pivoting, rolling or swinging gates, guard arms, and the like. Such systems often operate in response to a remotely sourced, unidirectional control signal. In an example, a user may operate a wireless remote control device to transmit an “open” command to a control system coupled to an actuator for moving a barrier, allowing the control system to control the barrier (e.g., to open the garage door, to open the gate, and so on).

A remote control transmitter, such as those used for garage door systems, security systems and other short-range wireless transmitters, includes a radio frequency transmitter that transmits a code on a specific radio frequency. The code is often generated using an encoder, and the transmission frequency is typically fixed by legislation within a particular country.

### SUMMARY

In an embodiment, a circuit includes an input terminal for receiving an input signal and a time stamp circuit including an input and an output. The input is coupled to the input terminal. The time stamp circuit includes a timer, and the output is for providing a time stamp based on a value of the timer in response to receiving the input signal. The circuit further includes an encoder including an input coupled to the output of the time stamp circuit and configured to encode the time stamp into a packet. The circuit also includes a transmitter configured to transmit the packet.

In another embodiment, a method includes receiving a signal corresponding to a user input at an input terminal of a circuit and generating a time stamp, using a timer of the circuit, in response to receiving the signal, where the time stamp corresponds to a value of a timer when the signal is received. The method further includes encoding the time stamp together to produce a packet using an encoder of the circuit and providing the packet to a communications link via a transmitter of the circuit.

In still another embodiment, a system includes a transmit device configured to transmit a packet through a wireless link, where the packet includes a time stamp. The transmit device includes a transmitter including an input and including an output for transmitting the packet, an encoder/packet generator including an input for receiving data including a time stamp and an output coupled to the input of the transmitter, and a time stamp circuit including a timer and configured to generate a time stamp corresponding to a value of the timer in response to an input signal. The system further includes a receiver device configured to receive the packet from the wireless link, to decode the packet to retrieve the time stamp, and to authenticate the packet using the time stamp. The receiver device is configured to ignore the packet when the time stamp falls outside of a time stamp window and to operate on the packet when the time stamp falls within the time stamp window.

### BRIEF DESCRIPTION OF THE DRAWINGS

FIG. 1 is a block diagram of a system including transmitting device that encodes a time stamp into packets and a receiving device that uses the time stamp to authenticate the received packet.

FIG. 2 is a block diagram of a portion of the transmitting device of FIG. 1 illustrating the formation of one possible type of packet having an encrypted payload including a time stamp.

FIG. 3 is a block diagram of a second embodiment of a transmitting device that is configured to encode a time stamp into transmitted packets.

FIG. 4 is a diagram of a time stamp value versus time for the time stamp circuit of FIG. 3.

FIG. 5 is a block diagram of an embodiment of a time stamp circuit having a volatile timer and a non-volatile timer and including both volatile and non-volatile memories for storing portions of the time stamp.

FIG. 6 is a diagram of amplitude versus time for the volatile timer output signal of the volatile timer of FIG. 5.

FIG. 7 is a diagram of amplitude versus time for a non-volatile timer output signal of the non-volatile timer of FIG. 5.

FIG. 8 is a block diagram of a portion of the transmitting device of FIG. 1 illustrating the formation of one possible type of packet having an encrypted payload including a time stamp that is scrambled.

FIG. 9 is a logic diagram of an embodiment of a scrambler circuit for producing a scrambled time stamp according to the transmitting device of FIG. 8.

FIG. 10 is a logic diagram of an embodiment of a descrambler circuit for descrambling the scrambled time stamp for use in the receiving device of FIG. 1.

FIG. 11 is a diagram of the time stamp value versus time for a scrambled time stamp according to the transmitting device of FIG. 8.

FIG. 12 is a diagram of the time stamp value versus time including reception windows for receiving a signal that includes a time stamp.

FIG. 13 is a flow diagram of a method for re-synchronizing the receiver to the transmitter time stamp when a transmission is received after a reception window has expired.

FIG. 14 is a diagram of the time stamp value versus time including time-varying reception windows for receiving a signal that includes a time stamp.

FIG. 15 is a block diagram of a system including a transmitter circuit configured to provide time-stamp based one-way communication security.

In the following discussion, the same reference numerals are reused to indicate the same or similar elements in different figures.

### DETAILED DESCRIPTION OF ILLUSTRATIVE EMBODIMENTS

Accordingly, embodiments of a system are described below that include a transmitter device configured to transmit a one-way communication package including a time-stamp and a receiver device configured to receive the one-way communication package and to decode it to authenticate the transmission. Such embodiments, when used in applications such as wireless control operations, for example as garage door openers, gate openers, and other one-way wireless control devices, can provide increased or improved security measures. The security measures include prevention or increased difficulty of compromising the control operation, for example, preventing unauthorized access to premises sought to be protected or secured.

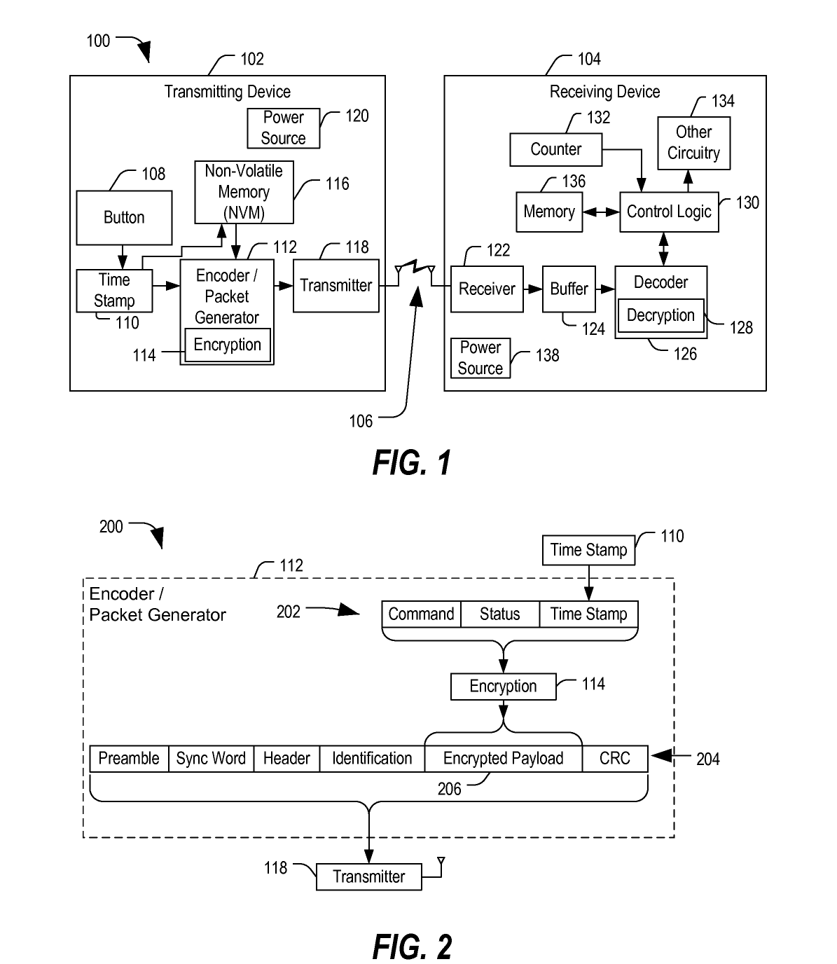

FIG. 1 is a block diagram of a system 100 including transmitting device 102 that encodes a time stamp in transmitted packets and a receiving device 104 that uses the time stamp to authenticate received packets. In an example, transmitting device 102 can be a portable remote control device, such as a garage door remote control, a key fob, or other portable remote control device. Receiving device 104 can be a garage door opener, a security panel, or other controllable electronic device.

Transmitting device 102 includes a user-selectable button 108 including an output coupled to an input of a time stamp circuit 110, which has a first output coupled to a non-volatile memory (NVM) 116 and a second output coupled to an encoder/packet generator 112. Time stamp circuit 110 provides a first portion of a time stamp to a non-volatile memory and a second portion of the time stamp to a volatile memory of encoder/packet generator 112. NVM 116 includes an output coupled to an input of encoder/packet generator 112. Encoder/packet generator 112 includes an encryption block 114 for encrypting the time stamp when the time stamp is encoded into a packet. In this particular example, encoder/packet generator 112 encodes the time stamp into a portion of a packet for transmission, such as a payload portion of the packet. Encoder/packet generator 112 includes an output coupled to an input of a transmitter 118, which has an output coupled to an antenna for transmitting packets wirelessly through a wireless communications link 106 to receiving device 104. Transmitting device 102 also includes a power source 120, such as a battery, which supplies power to the time stamp circuit 110, NVM 116, transmitter 118, and encoder/packet generator 112.

Receiving device 104 includes a receiver 122 including an input coupled to an antenna for receiving packets through wireless communications link 106 and including an output coupled to a buffer 124, which has an output coupled to an input of a decoder 126. Decoder 126 includes a decryption block 128 for decrypting the payloads of received packets. Further, decoder 126 includes an output coupled to an input of control logic circuit 130, which includes an input coupled to an output of a counter 132, and input/output interface coupled to a memory 136, and an output coupled to other circuitry 134. Additionally, receiving device 104 includes a power source 138, which can include a regulator and other circuitry for receiving a power supply from power outlet, such as a plug or wall socket.

As described in detail below, in exemplary embodiments, time stamp circuit 110 can be implemented using a simple counter and one or more memories for storing at least portions of the counter data. For example, the most significant bits of the time stamp value may be stored in NVM 116, while the least significant bits of the time stamp value may be stored in a volatile memory.

In an example, in response to a user pushing button 108, time stamp circuit 110 of transmitting device 102 generates a time stamp that is provided to encoder/packet generator 112 and a portion of which is provided to NVM 116. Encoder/packet generator 112 generates a communication packet that has a payload for carrying the time stamp and provides the communication packet to transmitter 118 for transmission to receiving device 104 through wireless communications link 106. In some instances, encoder/packet generator 112 encrypts the time stamp and places the encrypted time stamp into a payload of a packet together with other information before providing the packet to transmitter 118 for transmission to receiving device 104 through wireless communications link 106.

Receiving device 104 receives the packet at receiver 122, which provides the packet to buffer 124 for decoder 126 to decode (and optionally decrypt using decryption block 128) the packet. The decoded (and decrypted) packet is provided to control logic circuit 130, which can compare the time stamp value to a counter value from counter 132. If the time stamp value exceeds the counter value and is within an expected range, control logic circuit 130 determines that the received packet is valid, records the time stamp value in memory 136, and transmits other data from the packet payload to other circuitry 134, such as an actuator to open a gate or a garage door. If the time stamp value falls outside of the expected range or window, a recovery procedure is initiated using a shorter resynchronization window. In exemplary embodiments, receiving device 104 does not require a clock, but rather treats the time stamp values as numbers that can be readily compared to a counter value or range of counter values. This attribute can simplify receiving device 104 and/or reduce its cost.

In general, receiving device 104 opens a receive window and accepts transmissions that include a time stamp value that falls within the receive window. New valid time stamps then shift the next receive window forward in time. Receiving device 104 rejects old codes or repeated codes. Further, receiving device 104 does not need a timer. Instead, it treats the time stamp as a number and can authenticate the time stamp using a simple counter, such as counter 132.

In the above-example, encoder/packet generator 112 generates a packet having a payload portion. However, the time stamp value may be encoded into less structured types of packets of information. As used herein, the term “packet” refers to a bundle of data. In one instance, a packet may be a data packet, such as the types of data packets transmitted over the Internet. In another instance, a packet may include one or more pieces of data in a format that can be used for wireless transmission to the receiving device 104. For example, a packet may include multiple pieces of data in pre-defined portions, including for example a payload portion. In another example, a packet may include a time stamp and another piece of data.

Further, while the above discussion relates to transmission of a packet, a complete transmission between the transmitting device 102 and the receiving device 104 may include transmission of multiple packets. In one particular example, each of the multiple packets includes a time stamp and a piece of data. In another particular example, a first packet of the multiple packets includes a time stamp and optionally a piece of data, and the other packets may include just data. The receiving device 104 may authenticate the multiple packets if each of the packets is received within a window of time after the packet with the time stamp is received.

In general, system 100 provides a simple security implementation that prevents simple frequency hacking of the RF wireless transmission. In particular, by utilizing a counter that could represent time values spanning over 100 years, the time stamp circuit 110 can be configured to start at a time stamp value at some point within the 100 year window, thus making it difficult for a hacker to guess or to decipher using a brute force approach that would test each possible time stamp value. While the above discussion has mentioned packet transmissions, an example of an encoder/packet generator 112 is described below with respect to FIG. 2 that depicts an example of a packet including an encrypted payload that includes a time stamp value.

FIG. 2 is a block diagram of a portion 200 of the transmitting device 102 of FIG. 1 illustrating the formation of a packet having an encrypted payload including a time stamp. The portion 200 includes time stamp circuit 110 including an output coupled to an input of encoder/packet generator 112, which has an output coupled to transmitter 118.

Encoder/packet generator 112 generates a packet 204 for transmission via transmitter 118. Packet 204 includes an encrypted payload 206, which is encrypted using encryption block or circuit 114. Encryption block 114 receives data 202, including a command, a status indicator, and a time stamp value, encrypts data 202 to produce encrypted payload 206, and inserts the encrypted payload 206 into packet 204.

In this instance, a time stamp value can be produced using a counter, a clock, or other circuit that changes independent of a button press, ensuring that each transmitted packet is unique and appears uncorrelated to other packets once encrypted. The unique transmission values provide a first layer of security. Additionally, a timer can be used in the transmitter, and a simple counter can be used in the receiver to achieve the decode authentication function. Alternatively, both the transmitter device 102 and the receiver device 104 can use a counter, a timer, or a combination thereof.

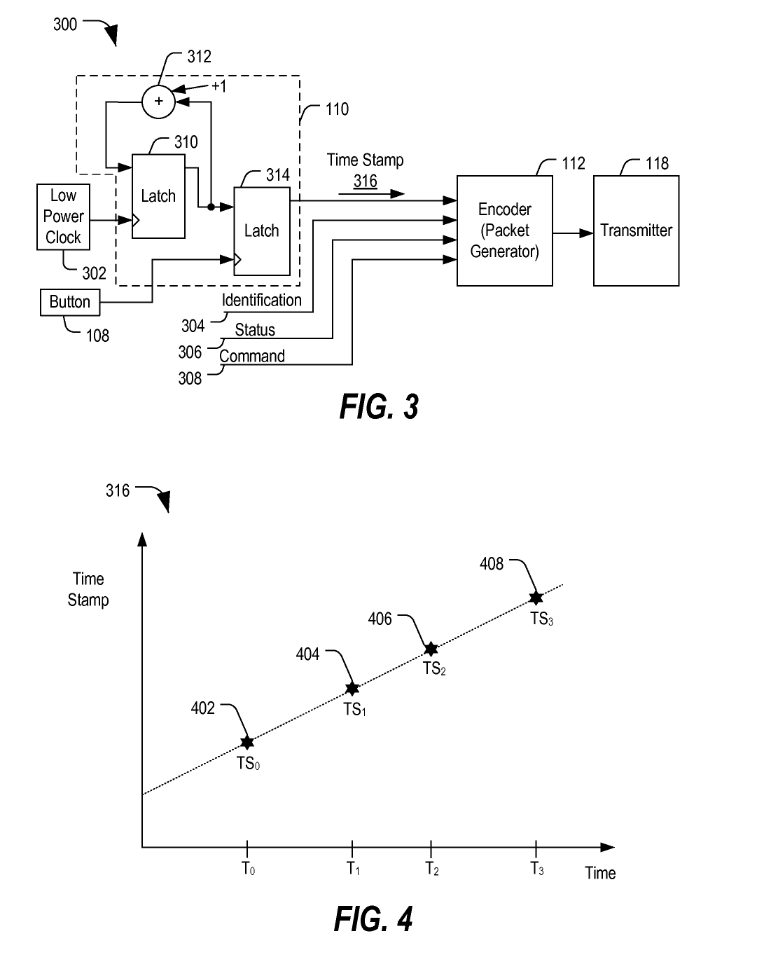

While the above discussion has provided an overview of a system 100 for providing a time-stamp based one-way communication technique, there are various ways of implementing a time stamp, as persons of ordinary skill in the art understand. It should be appreciated that a time stamp, as discussed herein, differs from a “rolling code” where each button press increments a counter for example, because the value of the increment of the time stamp value is independent of the button press. In other words, the time stamp value continues to change over a period of time between button presses and thus varies independent of the button press. The particular time stamp value is captured when the button is pressed. One possible example of a time stamp circuit is described below with respect to FIG. 3.

FIG. 3 is a block diagram of an embodiment of a transmitting device 300 that is configured to encode a time stamp into transmitted packets. Transmitting device 300 includes a low power clock 302 including an output coupled to time stamp circuit 110, which includes an output for providing a time stamp 316 to encoder/packet generator 112. Transmitting device 300 further includes a button 108 coupled to time stamp circuit 110. Encoder/packet generator 112 includes an output coupled to an input of transmitter 118, which transmits packets wirelessly to receiving device 104 through wireless communications link 106 (in FIG. 1).

Encoder/packet generator 112 includes a first input 304 for receiving identification data, a second input 306 for receiving status data, and a third input 308 for receiving other data, such as a command. In an example, the encoder/packet generator 112 receives time stamp 316 from time stamp circuit 110, identifier data that uniquely identifies the transmitting device 102, status data indicating (for example) a state of a battery of transmitting device 102, and one or more instructions or commands (or code representing the command(s)), such as “Open” or “Close” a door, which commands are transmitted to receiving device 104 for execution by control logic circuit 130 to perform a desired operation, provided the received packet has a time stamp that falls within the time stamp window.

Time stamp circuit 110 includes a latch 310 including a clock input coupled to the output of low power clock 302, an output coupled to a data input of latch 314, and a data input coupled to a node output of a summing node 312. Summing node 312 further includes a node input coupled to the output of latch 310. Summing node 312 increments the value at the output of latch 310 by a pre-defined increment and provides the incremented value to the input of latch 310. Thus, in response to the clock signal of the low power clock 302, the latch passes the value from its input to its output, incrementing a count. Latch 314 includes a data input coupled to the node output of summing node, a clock input coupled to the output of button 108, and an output for providing time stamp 316 to the input of encoder/packet generator 112.

In an alternative embodiment, low-power clock 302 can be replaced with a programmable oscillator or other programmable circuit, making it possible to change the frequency of the timer. Further, the time stamp 316 may be a number, such as a serial number, rather than a time, making it possible to uniquely tag each generated packet. In this instance, the time stamp refers to a unique number relative to other time stamps, but not necessarily to a time value.

In the illustrated example, latch 310 increments with each clock pulse from low power clock 302, and the value stored by latch 310 is provided to encoder/packet generator 112 when the user presses button 108, causing latch 314 to latch the value at its data input to its output. Thus, unlike a rolling code, time stamp circuit 110 produces a unique value that varies with a clock signal to produce a unique time stamp that is captured in response to each button press. An example of the time stamp value over time is described below with respect to FIG. 4.

FIG. 4 is a diagram 400 of a time stamp value versus time for the time stamp circuit 110 of FIG. 3. In diagram 400, the time stamp 316 varies linearly over time because the low power clock 302 provides a periodic increment. As shown, at first point in time (T₀) when button 108 is pressed, a first time stamp value (TS₀) 402 is latched by latch 314 and provided as time stamp 316 to encoder/packet generator 112. Subsequently, at a second point in time (T₁) when the button 108 is pressed again, a second time stamp value (TS₁) 404 is latched by latch 314 and provided as time stamp 316 to encoder/packet generator 112. Similarly, at times T₂ and T₃, corresponding time stamps (TS₂ and TS₃) 406 and 408 are latched by latch 314 and provided as time stamp 316 to encoder/packet generator 112.

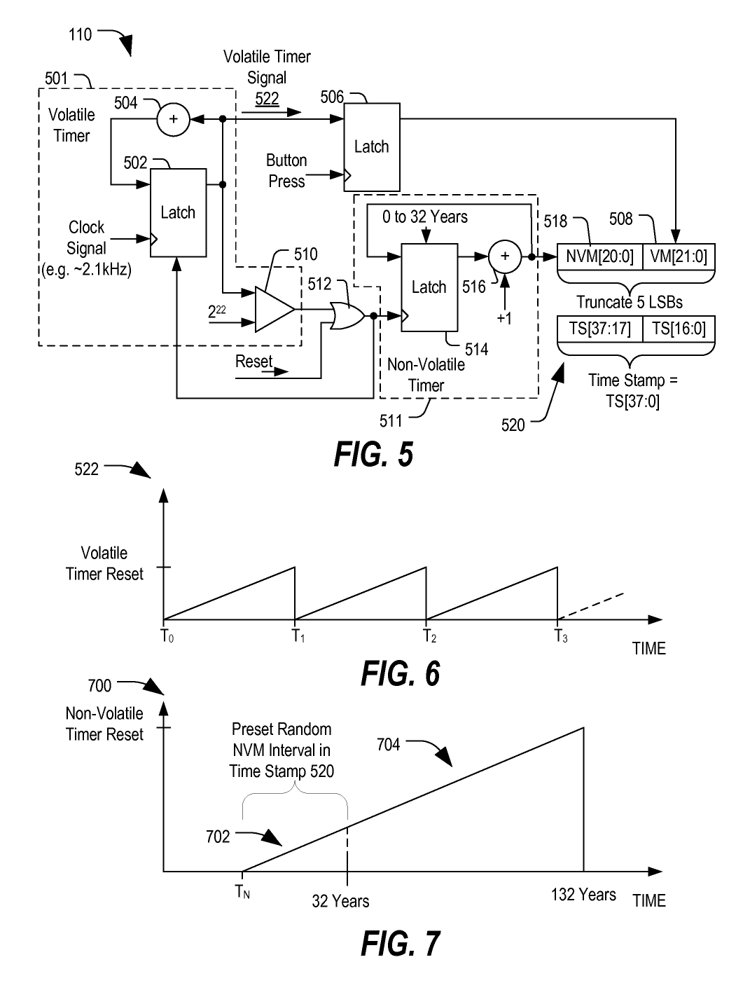

In this example, the low power clock 302 provides an incremental adjustment that produces unique time stamps for each button press. The unique time stamp can be encoded into a payload portion of the packet to be transmitted and used by receiving device 104 to authenticate the packet. In particular, each transmitted packet should have a time stamp that is greater than a previously received time stamp. This provides a first level of security with respect to one-way communications, such that an unauthorized packet having the wrong time-stamp value would be ignored by the receiving device 104. One possible embodiment of a time stamp circuit 110 having both a volatile and a non-volatile timer is described below with respect to FIG. 5.

FIG. 5 is a block diagram of an embodiment of a time stamp circuit 110 having a volatile timer 501 and a non-volatile timer 511 and including both a volatile memory 508 and a non-volatile memory 518 for storing portions of the time stamp. As used herein, the term “volatile timer” refers to a timer that produces a value that is stored in a volatile memory, while the term “non-volatile timer” refers to a timer that produces a value that is stored in a non-volatile memory. Time stamp circuit 110 includes a latch 506 having a data input coupled to an output of volatile timer 501 for receiving a volatile timer signal 522, a clock input for receiving a button press signal, and an output coupled to volatile memory 508 for storing least significant bits of a time stamp value.

Volatile timer 501 includes a latch 502 having a clock input for receiving a relatively low frequency clock signal (such as a clock signal having a frequency of approximately 2.1 kHz in some embodiments). Latch 502 further includes a data input coupled to a node output of summing node 504, which has a node input coupled to the output of latch 502. Further, the output of latch 502 is coupled to the data input of latch 506 and coupled to an input of a comparator 510. Comparator 510 further includes a second input for receiving a reset counter value and an output coupled to an input of an OR gate 512. OR gate 512 includes a second input for receiving a RESET signal. In this example, the reset counter value is set to 2²², which causes the output of comparator 510 to change at approximately 33 minute intervals or at in response to the RESET signal, thereby incrementing the non-volatile timer 511. Further, the output of OR gate 512 is coupled to a reset input of latch 502, for resetting latch 502.

Non-volatile timer 511 includes a latch 514 having a clock input coupled to the output of OR gate 512, a data input, and an output coupled to a node input of a summing node 516, which has a node output coupled to a non-volatile memory 518 and to the data input. In this example, latch 514 can be configured to store a value corresponding to a time value that is between year zero and year 32. Further, the starting value of non-volatile timer 511 can be adjusted by incrementing the value to a point in time that is far in the future. For example, the starting point for the non-volatile timer 514 can be initially set to 15 years in the future, providing an additional level of security in that the most significant bits of the time stamp value cannot be readily guessed or even reached by a brute force approach.

In an example, the clock signal at the clock input of latch 502 cause the value of the count of latch 502 to increase over time. When button 108 is pressed, latch 506 provides the current value at the output of latch 502 to the volatile memory 508. Further, when the value of latch 502 reaches a count of 2²², the volatile timer signal 522 is reset and non-volatile timer 511 is incremented.

By utilizing non-volatile memory 518 and volatile memory 508 in combination to store timer values, it is then possible to produce a time stamp that is a combination of the value stored in both memories. In this example, the time stamp value stored in the volatile memory is truncated by the five least significant bits and then the remaining values stored by volatile memory 508 are appended to (combined with) the time stamp value stored in the non-volatile memory 518 to produce a combined time value that represents a time stamp value 520 formed from bits zero through 37. In this example, a portion of the time stamp value stored in volatile memory 508 represents the least significant bits and the time stamp value stored in the non-volatile memory 518 represents the most significant bits of the time stamp value 520.

In this example, there are two reset intervals, one for the volatile timer 501 that corresponds to the value applied to the second input of comparator 510. In this instance, the value is set to 2²²; however, the counter could be adjusted depending on the size of the volatile memory 508. Further, the non-volatile memory 511 is configured to reset every 32 years. However, the value of the non-volatile timer 511 may be increased or decreased based on the size of the non-volatile memory 518 in combination with the volatile memory 508. Accordingly, it is possible to configure the non-volatile timer to reset over 10 years or every 100 years, for example, depending on the specific implementation.

In general, the volatile timer 501 increments more frequently than the non-volatile timer 511. Thus, the non-volatile timer 511 has an increment frequency that is less than an increment frequency of the first timer 501. For example, the volatile timer 501 represents a 22 bit timer having a clock frequency of 2.1 kHz. Each incremental interval of the volatile timer 501 is approximately 0.48 ms, and the timer resets every 33 minutes or 0.55 hours. Thus, the least significant bits of the time stamp are updated in volatile memory 508 every 0.48 ms. In contrast, the non-volatile memory increments in response to a reset signal or every 33 minutes. The non-volatile memory 518 can be implemented as an electrically erasable programmable read only memory (EEPROM) having 21 bits, the increments every 0.55 hours. The 21 bits provide the EEPROM with a memory that can represent 1,163,504 hours; 48,479 days; or 132.8 years. In this example, the non-volatile memory 518 is written to approximately 2.2 million times in 132.8 years, far fewer times than the volatile memory 508. Thus, by storing a first portion of the time stamp in volatile memory 508 and second portion in non-volatile memory 518, non-volatile memory endurance issues (such as those caused by flash memory erase/write cycles) can be avoided and overall power consumption is reduced with respect to non-volatile memory write operations. In particular, a first write frequency associated with the frequency of write operations corresponding to volatile memory 508 is higher than a second write frequency associated with the frequency of write operations corresponding to non-volatile memory 518. Thus, the number of write operations to the non-volatile memory is less than the write operations to the volatile memory, thereby avoiding endurance issues relating to wear-related damage to non-volatile memory 518. Depending on the technology used, such as semiconductor types and design and fabrication techniques, and depending on the desired level of security, other types of memory may be used in some embodiments. As an example, flash memory may be used in some implementations.

In some embodiments, it may be desirable to include a summing node having an input coupled to the output of latch 506 and an output coupled to volatile memory 508, where the summing node is configured to subtract the volatile timer signal 522 from a bit value of 2²², causing the volatile timer to count down until volatile timer resets. Alternatively or in addition, it may be desirable to decrease the increment frequency of the first timer circuit by adjusting the clock frequency over a period of time after receiving a button press signal.

While the above discussion describes one possible implementation that includes two timer intervals, it should be appreciated that the non-volatile timer 511 in conjunction with the non-volatile memory provides an opportunity to initialize the time stamp at a value that is a number of years in the future, so that the starting point of the time stamp is high enough that it would be difficult to determine through a brute force approach. One example of the volatile timer and non-volatile timer resets is described below with respect to FIG. 6.

FIG. 6 is a diagram of amplitude versus time for the volatile timer signal 522 at the output of the volatile timer 501 of FIG. 5. In the illustrated example, the volatile timer signal 522 increases linearly from a first time T₀ to a second time T₁, at which point the value of the volatile timer signal 522 has reached the reset value at the second input of comparator 510 (e.g., 2²²), causing the value of the output of OR gate 512 to toggle and resetting the volatile timer 501. The volatile timer signal 522 increases linearly between second time (T1) and third time (T2) and then resets again, and so on. Thus, the value at the second input of comparator 510 sets the reset timing for volatile timer 501. If a reset is initiated via a reset signal applied to OR gate 512, the reset of volatile timer signal 522 may happen in response to the reset signal, and then the non-volatile timer resets and the volatile timer signal 522 linearly increases again.

FIG. 7 is a diagram of amplitude versus time for a non-volatile timer output signal 700 of the non-volatile timer 511 of FIG. 5. In this instance, the non-volatile timer signal 704 would have a zero value until a time T_{N} when either a reset signal is received at the second input of OR gate 512 or until the volatile timer signal 522 reaches a value that exceeds the threshold value (e.g., 2²²). The initial time value of the non-volatile timer 511 could be set to a non-zero value. For example, the non-volatile timer 511 could be configured to store a time stamp that spans a range of zero to 132 years, and the initial value of the non-volatile portion of the time stamp could be configured, for example, to be 32 years in the future.

In an example, the non-volatile portion of the time stamp can be present to a random number from 0 to 32 years, for example, to make it harder to hack into. The value can be preset, for example, by a manufacturer once. By configuring the non-volatile portion of the time stamp to a time far into the future, a layer of security is added that makes a brute force approach less likely to be successful without requiring a long period of time to test different time stamp values.

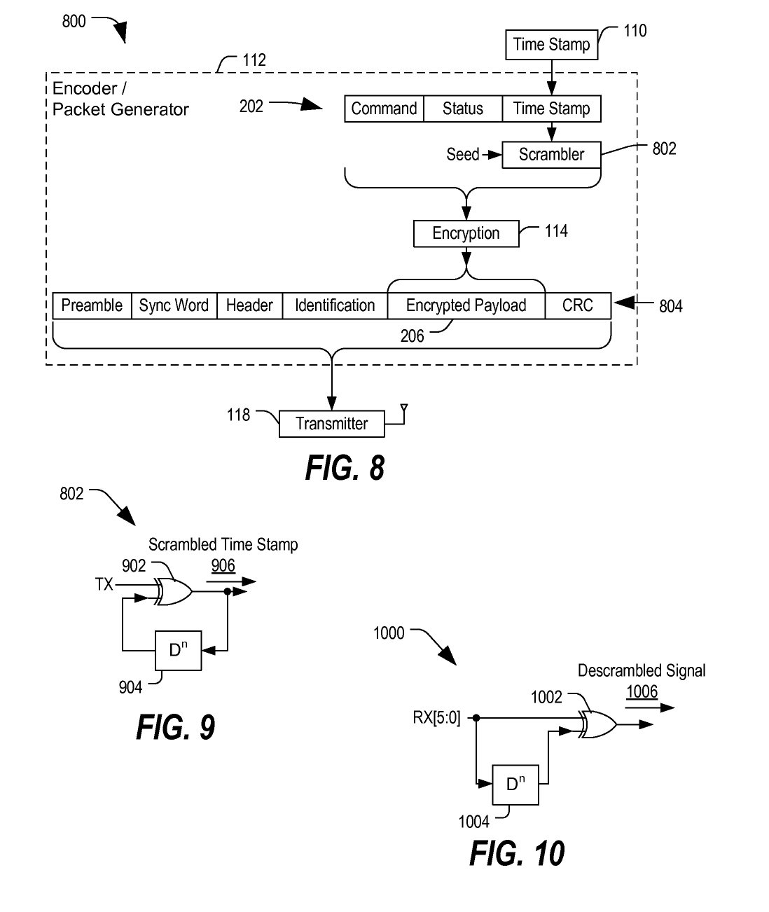

FIG. 8 is a block diagram of a portion 800 of the transmitting device 102 of FIG. 1 illustrating a second example of the formation of a packet having an encrypted payload including a time stamp that is scrambled. In this example, a time stamp circuit 110 provides a time stamp value to encoder/packet generator 112. Encoder/packet generator 112 receives data including command data, status data, and the time stamp value. Encoder/packet generator 112 includes a scrambler 802 that receives seed data and that applies the seed data to scramble the time stamp value. After scrambling the time stamp value, the data 202 and the scrambled time stamp value are encrypted by encryption block and loaded into the encrypted payload portion 206 of packet 804, which is provided to transmitter 118 for transmission to receiving device 104.

In this example, if delay block 904 has a delay variable (N=2), then the bit value at the output is provided to the second input of the exclusive OR gate 902 after a two bit delay. Thus, if the value of the input is “1” (i.e., 00001), the scrambler delays the one value two bits and provides it to the exclusive OR gate 902, where it is exclusive OR-ed with the zero value of bit 3 to produce a “1” value, which is exclusive OR-ed (after a two bit delay) with the zero value of bit 5 to produce a “1” value. Accordingly, the scrambled time stamp has a decimal value of 21 or a bit value of 10101, as described below in Table 1.

By scrambling the time stamp value before encrypting it into the payload 206 of packet 804, guessing or hacking the next unencoded time stamp value is made more difficult. In an example, the seed for the scrambler can be a function of an identification number of the transmitting device 102.

FIG. 9 is a logic diagram of an embodiment of a scrambler circuit 802 for producing a scrambled time stamp according to the portion 800 of the transmitting device 102 of FIG. 8. Scrambler circuit 802 includes an exclusive OR gate 902 including a first input for receiving the time stamp, a second input, and an output for providing the scrambled time stamp 906. Scrambler circuit 802 further includes a delay block 904 having an input coupled to the output and an output coupled to the second input of the exclusive OR gate 902.

In an example, exclusive OR gate 902 performs an exclusive OR operation on the bits of the time stamp with a delay operation corresponding to the bits at the output of the exclusive OR gate 902. When the variable (N) of the delay block 904 is equal to a value of two, a transmitted bit value of “1” (i.e., 00001) is translated to a scrambled value of 21 (i.e., 010101). While the above example uses a variable (N) having a value of N=2, other values of variable (N) may be used, depending on the system.

FIG. 10 is a logic diagram of an embodiment of a descrambler circuit 1000 for descrambling the scrambled time stamp 906 for use in the receiving device 104 of FIG. 1. In this example, descrambler 1000 includes an exclusive OR gate 1002 including a first input for receiving the scrambled time stamp 906, a second input, and an output for providing a descrambled time stamp signal 1006. Descrambler 1000 includes a delay block 1004 having an input coupled to the first input of exclusive OR gate 1002 and an output coupled to the second input of exclusive OR gate 1002. By setting the variable (N) to equal the variable (N) in the delay block of the scrambler 802 of the transmitting device 102, the descrambler 1000 can decode the scrambled time stamp. An example of the transmitted value, the scrambled value, and the descrambled value is depicted below in Table 1.

TABLE 1
Time Stamp Value, Scrambled Value, and Descrambled Value.

| Time Stamp Value | | Scrambled Value | | Descrambled Value | |
|---|---|---|---|---|---|
| Decimal | Binary | Decimal | Binary | Decimal | Binary |
| 0 | 00000 | 0 | 00000 | 0 | 00000 |
| 1 | 00001 | 21 | 010101 | 1 | 00001 |
| 2 | 00010 | 42 | 101010 | 2 | 00010 |
| 3 | 00011 | 63 | 11111 | 3 | 00011 |
| 4 | 00100 | 20 | 010100 | 4 | 00100 |
| 5 | 00101 | 1 | 000001 | 5 | 00101 |
| 6 | 00110 | 62 | 111110 | 6 | 00110 |
| 7 | 00111 | 43 | 101011 | 7 | 00111 |
| 8 | 01000 | 40 | 101000 | 8 | 01000 |

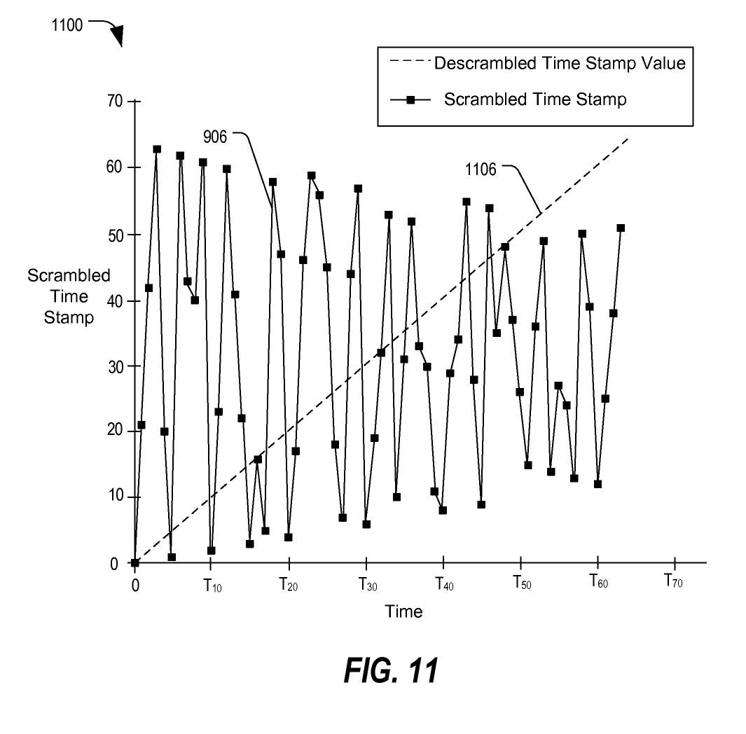

Thus, as depicted in Table 1, the scrambler 802 produces a scrambled time stamp 906 that makes it difficult for an unauthorized user to guess or hack the transmitted packet. An example of a graph of the scrambled time stamp 906 is described with respect to FIG. 11.

FIG. 11 is a diagram 1100 of the time stamp value versus time for a scrambled time stamp 906 according to the transmitting device of FIG. 8, for a delay of two. In this example, the time stamp value increases linearly as indicated by dashed line 1106. Accordingly, upon decoding, the scrambled time stamp 906 can be resolved to a corresponding descrambled time stamp value along line 1106. In the illustrated example, the scrambled time stamp value 906 varies relative to the time stamp values represented by dashed line 1106.

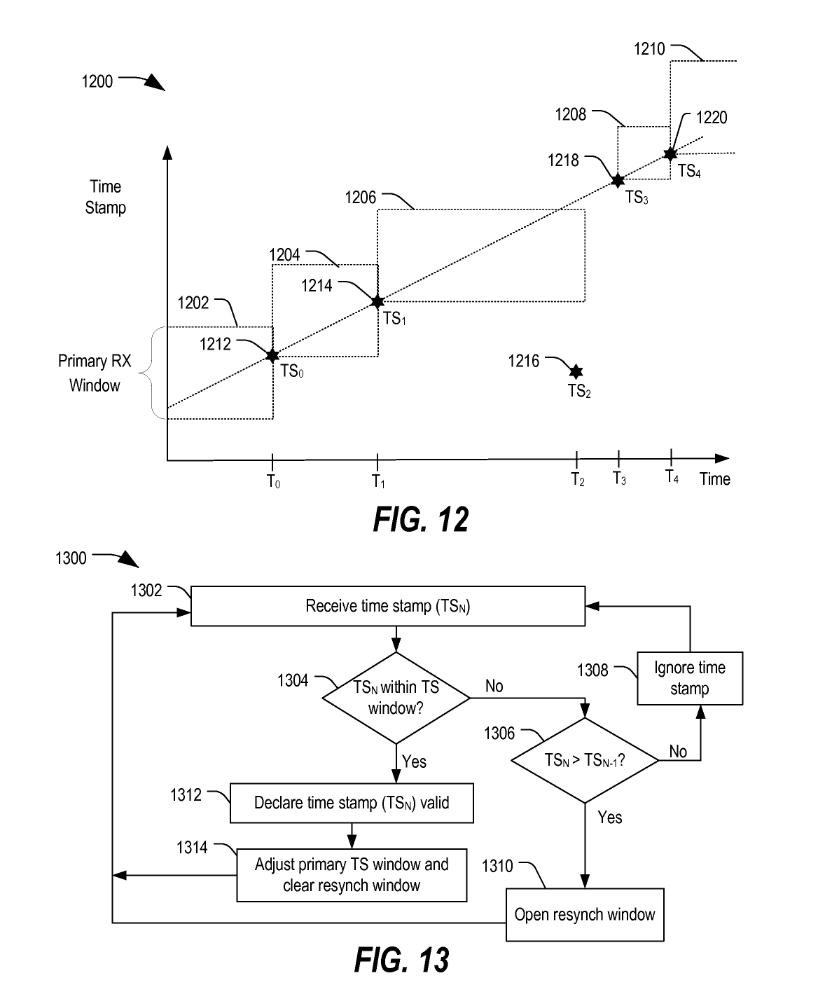

While the above-described example uses a delay of two, other delays may also be used. For example, a delay of three or four could readily be implemented that would also provide adequate time stamp security. Further, once the scrambled time stamp is received, the receiving device 104 descrambles and decodes the time stamp value and then determines whether the time stamp value falls within a valid “transmit” window. An example of a diagram depicting the time stamp value relative to various transmit windows is described below with respect to FIG. 12.

FIG. 12 is a diagram 1200 of the time stamp value versus time including time stamp windows 1202, 1204, 1206, and 1210 (sometimes called “reception windows”) for receiving a signal that includes a time stamp. The transmitted time stamp value (TSᵢ) is stored in a non-volatile memory 136 of receiving device 104. Each time stamp window defines a range of values that will be recognized by receiving device 102 as a valid time stamp. Each new time stamp window is created upon receipt of a valid time stamp. Thus, upon receipt of a first time stamp (TS₀) 1212 within first time stamp window 1202, the first time stamp window 1202 is terminated and a second time stamp window 1204 is created. Similarly, upon receipt of a second time stamp (TS₁) during the second time stamp window 1204, the second time stamp window 1204 is terminated and a third time stamp window 1206 is created. A time stamp value is valid if the value of the time stamp is greater than that of the previous time stamp and within the time stamp window.

In this example, the time stamp windows have a finite duration. If a time stamp value is received (such as time stamp TS₂ 1216 at third time (T₂)). The third time stamp window 1206 is terminated. However, because the third time stamp (TS₂) 1216 falls outside of the range defined by the third time stamp window 1206. Thus, in this instance, the third time stamp (TS₂) 1216 will be rejected or ignored, and the control logic circuit 130 initiates a recovery procedure using a smaller resynchronization window 1208. In this instance, both the third and fourth time stamp values (TS₂ and TS₃) fall outside of the time stamp window 1206. However, the fourth time stamp value (TS₄) is close enough to a valid value of the time stamp that the control logic circuit 130 initiates a resynchronization process. To trigger resynchronization, the difference between the time stamp value and an expected time stamp value should be less than a threshold. Alternatively, the time stamp value should be greater than the previous time stamp value and greater than the expected time stamp value by a pre-determined amount.

When the fifth time stamp (TS₄) 1220 is received within resynchronization window 1208, control logic circuit 130 initiates a new time stamp window 1210. If a new time stamp value is received that falls within the new time stamp window 1210, the control logic circuit 130 determines that the packet is valid. In this example, the receiving device 104 does not need a clock, but rather can treat the time stamp values as raw numbers, making decoding of the time stamp value relatively simple.

In an example, the time stamp window can be configured to have a maximum duration of approximately one week. A smaller window provides a more secure system relative to a system that does not limit the time stamp window. Further, using more re-sychronization operations increases the number of button presses, thereby increasing the number of transmissions and possibly negatively impacting the user's experience.

In one instance, the resynchronization window 1208 can be limited to about 15 seconds, for example. When a user presses the button 108, nothing happens, so the user presses the button again. Thus, the resynchronization window also provides a more secure system. In an embodiment, control logic circuit 130 allows only one time stamp window and one resynchronization window to be open at a time.

While the above diagram depicts the time stamp and resynchronization windows, the system 100 implements a method for receiving time stamps. An example of one possible embodiment of a method of receiving time stamps via a one-way communication link is described below with respect to FIG. 13.

FIG. 13 is a flow diagram of a method 1300 for re-synchronizing the receiver to the transmitter time stamp when a transmission is received after a reception window has expired. The receiving device 102 receives a packet that includes a time stamp that may be encrypted and/or scrambled. Receiving device 102 decodes the packet and recovers the time stamp. The time stamp value is provided to control logic circuit 130.

At 1302, control logic circuit 130 receives the time stamp value (TS_{N}). Advancing to 1304, if the time stamp value (TS_{N}) falls within the time stamp window, the method advances to 1312 and control logic circuit 130 declares the time stamp (TS_{N}) valid. The method 1300 continues to 1314 and control logic circuit 130 adjusts the primary window and clears the resynchronization window. The method 1300 then returns to 1302 and control logic circuit 130 receives a next time stamp value.

Returning to 1304, if the time stamp (TS_{N}) falls outside of the time stamp window, the method 1300 advances to 1306 to determine if the time stamp value (TS_{N}) is greater than the previously received time stamp value (TS_{N-1}). If not, the method 1300 advances to 1308 and the control logic circuit 130 ignores the time stamp and the corresponding packet. Otherwise, at 1306, if the time stamp value (TS_{N}) is greater than the previous time stamp value (TS_{N-1}), the method 1300 advances to 1310 and control logic circuit 130 opens a resynchronization window (such as resynchronization window 1208 in FIG. 12).

In some instances, such as when a battery is changed in the transmit device 102, the time stamp may be reset. In one example, a second of two consecutive false transmissions (i.e., transmissions having time stamp values that differ from the expected time stamp value by more than a pre-determined threshold) may be passed as valid, where the second false transmission is greater than the first and greater than the expected time stamp value, but within the resynchronization window. In an example, when power source 120 of transmitting device 102 is replaced, the volatile portion of the time stamp is deleted and the non-volatile portion of the time stamp is incremented, such that the resulting time stamp value is greater than the previous time stamp value but outside of the time stamp window. In this instance, after resynchronization, the second time stamp value can be passed as a valid time stamp value.

In this instance, when a reset occurs, the volatile timer is reset to zero, which means that the time stamp value can lose up to 33 minutes. The non-volatile memory will be incremented, moving the time stamp value ahead by 33 minutes. As a result, the time stamp value cannot go backward but can advance up to 33 minutes, shortening the effective size of time stamp windows in the receiver. In particular, the time stamp value can be bumped outside of the time stamp window by the reset operation, causing the control logic circuit 130 to reject the time stamp value. However, the invalid time stamp value causes the control logic circuit 130 to initiate resynchronization, and if the next time stamp has a value greater than the previous time stamp that falls within the resynchronization window, the control logic circuit 130 can resynchronize to the new time stamp value.

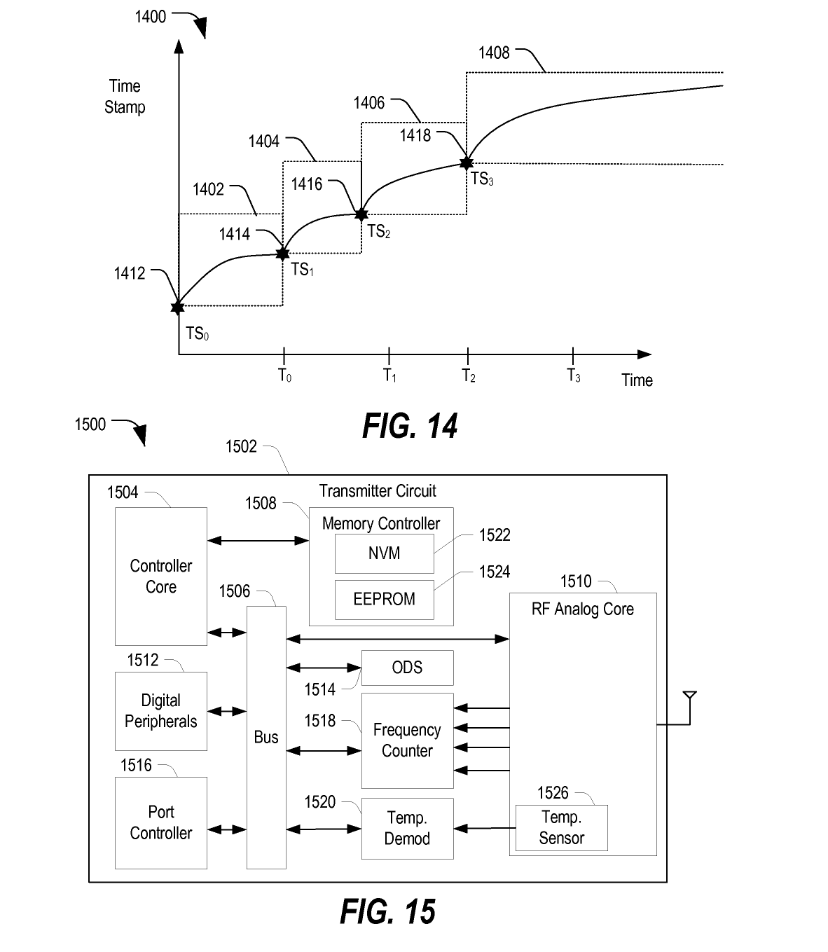

In the above discussion, the time stamp value is based on a low-power clock having a substantially constant frequency, causing the time stamp value to increase substantially linearly over time. However, it is possible to vary the clock frequency over time, both to extend the battery life of the transmitting device 102 and to decrease the frequency of the write operations to the non-volatile memory after a button press. This allows for a smaller resynchronization window after long intervals with no button presses. A diagram of the time stamp value versus time for a time stamp produced using a time-varying clock is described below with respect to FIG. 14.

FIG. 14 is a diagram 1400 of the time stamp value versus time including time-varying reception windows for receiving a signal that includes a time stamp. In the illustrated example, diagram 1400 includes time stamp windows 1402, 1404, 1406, and 1408, which extend indefinitely until a next time stamp value is received. For example, time stamp window 1402 extends from receipt of a first time stamp (TS₀) 1412 until a second time stamp (TS₁) 1414 is received, at which point a second time stamp window 1404 begins. The second time stamp window 1404 extends until a third time stamp (TS₃) 1416 is received, at which point a third time stamp window 1406 begins. The third time stamp window 1406 extends until fourth time stamp (TS₃) 1418 is received. The fourth time stamp window 1408 extends indefinitely.

In the illustrated example, time stamp values do not vary linearly, but rather exponentially, such that the rate of increase of the time stamp value decreases over time. As a result, the time stamp value does not increase as much over time as if the clock maintained a substantially constant period. By varying the clock, the rate of change of the time stamp value decreases over time, allowing the time stamp window 1408 to remain valid for a much longer period without resynchronization. This makes it possible to decrease the frequency of the write operations to the non-volatile memory 116 after a button press. Further, this allows for smaller time stamp windows with less probability of missing the window after long intervals without button presses.

FIG. 15 is a block diagram of a system 1500 including a transmitter circuit 1502 configured to provide time-stamp based one-way communication security. Transmitter circuit 1502 includes a controller core 1504 coupled to a memory controller 1508 including a non-volatile memory 1522 and an electrically erasable programmable read only memory (EEPROM) 1524. As noted above, depending on the available technology, design, and desired performance characteristics, in some embodiments, other types of memory, such as flash, may be used. Further, controller core 1504 is coupled to one or more digital peripherals 1512, a port controller 1516, an output data serializer (ODS) 1514, a frequency counter 1518, a temperature demodulator 1520, and a radio frequency (RF) analog core 1510 through a bus 1506. RF analog core 1510 includes a temperature sensor 1526, which is coupled to temperature demodulator. Further, RF analog core 1510 is coupled to frequency counter 1618 and to an antenna.

In an example, the transmitter circuit 1502 is a fully integrated RF transmitter with an embedded micro controller unit (MCU) as the controller core 1504. The controller core 1504 operates on instructions stored in NVM 1522 and EEPROM 1524. In this instance, digital peripherals 1512 include a real time clock (RTC) and one or more timers that can be used to provide the periodic or time-varying input for calculating the time stamp. Further, digital peripherals 1512 include an advanced encryption standard (AES) hardware accelerator for encrypting the time stamp value. In an alternative embodiment, the MCU may be replaced by a general purpose or special purpose processor configured to execute instructions stored in memory. As persons of ordinary skill in the art understand, however, a variety of types of encryption engines or hardware may be used in exemplary embodiments, depending on factors such as cost, complexity, strength of encryption, etc.

In an example, the time stamp circuit can be implemented in instructions executing on the controller core 1504 in conjunction with the timer or RTC of digital peripherals 1512. Controller core 1504 can store a portion of the time stamp value in volatile memory and store a portion of the time stamp value in NVM 1522. Further, RF analog core 1510 includes a local oscillator, power amplifiers, tuning circuitry, and other circuitry (not shown), allowing the RF analog core 1510 to transmit packets including the time stamp value to a remote device through a wireless link, such as wireless link 106 in FIG. 1.

In conjunction with the systems, circuits, diagrams, and methods described above with respect to FIGS. 1-15, a system is disclosed that includes a transmitter device that encodes a time stamp into a payload of a packet for transmission via a one-way communications link and transmits the packet to a receiving device through a communications link. The receiving device includes a control logic circuit configured to decode the packet to recover the time stamp and to authenticate the packet based on the time stamp. In an example, the receiving circuit authenticates the packet by comparing the time stamp to a previously received time stamp value. If the time stamp is greater than the previously received time stamp value and within a time stamp window, the control logic circuit recognizes the packet as being valid. Otherwise, the packet is ignored.

If the time stamp is greater than the previous time stamp value but outside of the time stamp window, the control logic circuit initiates a resynchronization process, which provides a resynchronization window that is smaller than the time stamp window for receiving a second time stamp value for re-synchronizing the receiver device to the time stamp from the transmitter device. By utilizing a time stamp for authentication, the security of the one-way communication is improved by making each transmission packet unique relative to other transmission packets. Further, by using a unique combination of non-volatile and volatile memory to store portions of the time stamp, the reset effect due to battery changes is minimized. Further, utilizing a scrambler in connection with the time stamp further enhances security. Finally, having the ability to adjust the frequency of the timer makes it possible to reduce the time stamp window size in the receiver to further enhance security. Adjusting the clock rate used to produce the time stamp can extend the time that each time stamp is valid at the receiver device. This can reduce the number of “second button presses” needed for resynchronization.

The time stamp circuit includes a volatile timer and a non-volatile timer configured to produce a volatile portion of the time stamp and a non-volatile portion of the time stamp, respectively. In an example, the volatile portion of the time stamp is stores least significant bits of the time stamp, while the non-volatile portion of the time stamp stores the most significant bits of the time stamp. Further, the volatile portion of the time stamp updates in response to user input signals and the non-volatile portion of the time stamp updates each time the timer of the volatile time stamp circuit exceeds a pre-determined threshold value.

Although the present invention has been described with reference to preferred embodiments, workers skilled in the art will recognize that changes may be made in form and detail without departing from the scope of the invention.

1. An apparatus comprising:
an input terminal for receiving an input signal;
a time stamp circuit having an input coupled to the input terminal, the time stamp circuit including a timer and having an output for providing a time stamp based on a value of the timer in response to receiving the input signal;
an encoder including an input coupled to the output of the time stamp circuit and configured to encode the time stamp into a packet; and
a transmitter configured to transmit the packet.

2. The apparatus of claim 1, wherein the encoder encrypts the time stamp before encoding the time stamp into the payload portion.

3. The apparatus of claim 1, wherein the timer comprises:
a first latch including a data input, a clock input for receiving a clock signal, and an output;
a summing node including a node input and a node output and configured to increment a value at the node input and to provide the incremented value to the node output, the node input coupled to the output of the first latch, the node output coupled to the data input of the first latch; and
a second latch including a data input coupled to the output of the first latch, a clock input coupled to the input terminal, and the output for providing the time stamp.

4. The apparatus of claim 1, wherein the timer comprises:
a first timer configured to generate a first timer output;
a second timer to generate second timer output having a pre-determined offset; and
wherein the time stamp is derived from the first and second timer outputs.

5. The apparatus of claim 4, further comprising:
a first memory to store the first timer output in response to the input signal from the input terminal;
a second memory to store the second timer output periodically; and
wherein:
a first write frequency of the volatile timer that is associated with writing the first timer output to the first memory is greater than a second write frequency of the second timer that is associated with writing the second timer output to the second memory; and
the second timer is configurable to gradually decrease the second write frequency over a period of time.

6. The apparatus of claim 4, wherein the first timer comprises:
a first latch including a data input, a clock input for receiving a clock signal, a reset input, and an output;
a summing node including a node input and a node output, the node input coupled to the output of the first latch, the node output coupled to the data input of the first latch, the summing node configured to increment a value received at the node input and to provide the incremented value to the node output;
a second latch including a data input coupled to the output of the first latch, a clock input coupled to the input terminal, and an output coupled to the second memory; and
a comparator including a first input coupled to the output off the first latch, a second input for receiving a pre-determined threshold, and a comparator output; and
wherein the comparator output is coupled to the reset input of the first latch to reset the time stamp when a signal on the comparator output transitions from a logic low value to a logic high value.

7. The apparatus of claim 6, wherein the second timer comprises:
a third latch circuit including a data input, a clock input, and an output, the clock input coupled to the comparator output; and
a summing node including a node input coupled to the output of the third latch circuit and a node output coupled to the non-volatile memory and to the data input of the third latch circuit, the summing node configured to increment a value at the node input and to provide the incremented value to the node output.

8. A method comprising:
receiving a signal corresponding to a user input at an input terminal of a circuit;
generating a time stamp, using a timer of the circuit, in response to receiving the signal, the time stamp corresponding to a value of the timer when the signal is received;
encoding the time stamp to produce a packet using an encoder of the circuit; and
providing the packet to a communication link via a transmitter of the circuit.

9. The method of claim 8, wherein the method further comprises:
scrambling the time stamp using seed data; and
encrypting the payload of the packet.

10. The method of claim 9, wherein the seed data comprises a portion of an identification number associated with the circuit.

11. The method of claim 8, wherein generating the time stamp comprises:
generating a first time value using a first timer in response to receiving the signal;
combining the first time value with a second time value from a second timer to produce a combined time value; and
selectively truncating bits of one of the first time value and the second time value to produce the time stamp.

12. The method of claim 11, wherein selectively truncating the bits comprises truncating a selected number of least significant bits of the first time value.

13. The method of claim 11, wherein combining the first time value with the second time value comprises appending the first time value to the second time value such that the second time value represents most significant bits of the time stamp.

14. The method of claim 11, further comprises:
generating the second time value using the second timer having an increment frequency that is less than an increment frequency of the first timer; and
decreasing a frequency with which at least one of the first timer and the second timer is incremented over a period of time after receiving the signal.

15. A system comprising:
a transmit device configured to transmit a packet through a wireless link, the packet including an encrypted time stamp, the transmit device comprising:
a transmitter including an input and including an output for transmitting the packet;
an encoder/packet generator including an input for receiving data including a time stamp and an output coupled to the input of the transmitter; and
a time stamp circuit including a timer, the timer stamp circuit configured to generate a time stamp corresponding to a value of the timer in response to an input signal.

16. The system of claim 15, further comprising:
a receiver device configured to receive the packet from the wireless link, to decode the packet to retrieve the time stamp, and to authenticate the packet using the time stamp, the receiver device configured to ignore the packet when the time stamp falls outside of a time stamp window and to operate on the packet when the time stamp falls within the time stamp window; and
wherein the receiver device includes a control logic circuit to initiate a resynchronization process when the time stamp is greater than a previous time stamp but outside of the time stamp window.

17. The system of claim 16, wherein the control logic circuit uses a resynchronization window that is smaller than the time stamp window for receiving a second input signal having a new time stamp that is greater than the time stamp.

18. The system of claim 15, wherein the time stamp circuit comprises:
a first latch including a data input, a clock input for receiving a clock signal, and an output;
a summing node including a node input and a node output, the node input coupled to the output of the first latch, the node output coupled to the data input of the first latch, the summing node configured to increment a value at the node input and to provide the incremented value to the node output; and
a second latch including a data input coupled to the output of the first latch, a clock input coupled to the input terminal, and the output for providing the time stamp.

19. The system of claim 15, wherein the time stamp circuit comprises:
a first timer configured to generate a first timer output;
a second timer to generate a second timer output having a pre-determined offset; and
wherein the second timer output and the first timer output are combined to form the time stamp.

20. The system of claim 19, wherein the transmitter, the encoder/packet generator, and the time stamp circuit are implemented in processor readable instructions and hardware of an integrated circuit, the integrated circuit comprising:
a processor;
a memory accessible to the processor for storing instructions and timer data; and
one or more timers coupled to the processor.
